(19) United States
(12) Patent Application Publication
(10) Pub. No.: US 2022/0038920 A1
(43) Pub. Date: Feb. 3, 2022

(54) SAMPLE MEASUREMENT TOA CORRECTION

(71) Applicant: Nokia Technologies Oy, Espoo (FI)

(72) Inventors: Oana-Elena BARBU, Aalborg (DK); Mikko SÄILY, Laukkoski (FI); Diomidis MICHALOPOULOS, Munich (DE); Benny VEJLGAARD, Gistrup (DK)

(21) Appl. No.: 17/373,067

(22) Filed: Jul. 12, 2021

(30) Foreign Application Priority Data
Jul. 28, 2020 (FI) 20205773

(51) Int. Cl. H04W 16/28; H04W 24/10; H04W 64/00

(52) U.S. Cl. CPC H04W 16/28; H04W 64/006; H04W 24/10

(57) ABSTRACT

Inter-alia, a method is disclosed comprising: obtaining at least two sets of sample measurements, wherein a respective set of sample measurements thereof is indicative of one or more signals that are observable by an antenna, wherein a respective set of sample measurements of the at least two sets of sample measurements is measured with a respective antenna of at least two antennas, and wherein the two antennas have a distance from one another and are comprised by or connectable to an apparatus; determining time-of-arrival, TOA, difference information indicative of a TOA difference between the at least two sets of sample measurements, wherein the TOA difference information is determined based, at least in part, on at least two sets of sample measurements, the determining comprising checking whether the TOA difference reflects said distance between the at least two antennas. Corresponding apparatus, computer program and system are further disclosed.

### FIELD

The following disclosure relates to the field of positioning, or more particularly relates to systems, apparatuses, and methods for Time-of-Arrival (TOA) correction occurring across antennas of a mobile device, e.g. enabling accurate orientation determining of the mobile device.

### BACKGROUND

There are numerous automated operations anticipated for industrial applications. A big part of such applications associates to autonomous or semi-autonomous operation of vehicles, referred to as automated guided vehicles (AGVs). AGVs such as e.g. (lifting) trucks are typically installed with a hoisting device which has its own dimensions and maneuverability. It is beneficial that the position of AGVs is obtained with high accuracy as well as in (relatively) real time.

Besides positioning, however, many applications prefer that the orientation of such AGVs is also obtained with high accuracy and low latency, such that certain operations are successfully performed. Examples of such orientation-sensitive applications are loading/unloading of goods to/from mobile automated forklifts or trucks, where the “facing” of the mobile device is used for the flawless loading or unloading of goods.

A user equipment (UE) orientation is a different topic which is partially independent from UE positioning, in the sense that knowing the position of a UE does not necessarily provide information on the orientation of the UE, and vice versa. The positioning methods available in 3GPP standards (e.g. Downlink Time Difference of Arrival (DL-TDOA), Uplink Time Difference of Arrival (UL-TDOA), Downlink Angle of Departure (DL-AoD), Uplink Angle of Arrival (UL-AoA), Multi-cell Round Trip Time (Multi-RTT)) focus on obtaining the position of the UE with some level of accuracy, yet they do not provide orientation information. As a result, the UE orientation can up to date be estimated via radio access technology (RAT)-independent methods, such as inertia measurements units or other similar sensors. Such solutions, however, are not related to the network operation; in other words, network infrastructure products cannot currently provide a complete solution that includes both positioning and orientation targeted for industrial UEs.

Deriving UE positioning and/or orientation involves in a network-based, RAT-dependent approach measurements at the UE side which are often performed across multiple antenna panels.

### SUMMARY OF SOME EXEMPLARY EMBODIMENTS

However, it is a drawback that there is no guarantee that the different measurements across such panels correspond to the same multipath component. That is, in case, for instance, antenna 1 measures a line-of-sight (LoS) path from a gNB, while antenna 2 measures another reflected nLoS path coming from the same gNB, then the overall orientation estimation at the network may suffer decreased orientation accuracy. As a result, new approaches are developed which consider the LoS/nLoS measurement across multiple antennas (or antenna panels) at the UE.

It is thus, inter alia, an object of the invention to enable provision of sample measurements that are suited for determining an orientation of a respective mobile device.

According to a first exemplary aspect of the present invention, a method is disclosed, the method comprising:
gathering or obtaining at least two sets of sample measurements, wherein a respective set of sample measurements of the at least two sets of sample measurements is indicative of one or more signals that are observable by an antenna, wherein a respective set of the at least two sets of sample measurements is measured with a respective antenna of at least two antennas, and wherein the at least two antennas have at least one pre-defined distance from one another and are comprised by or connectable to the apparatus;
determining time-of-arrival, TOA, difference information indicative of a TOA difference between the at least two sets of sample measurements, wherein the at least one TOA difference information is determined based, at least in part, on at least two sets of sample measurements, wherein the determining comprises checking whether the TOA difference reflects the pre-defined distance between the at least two antennas.

This method may for instance be performed and/or controlled by an apparatus, for instance a function of a mobile communication network, e.g. a Location Management Function (LMF), and/or a Location Management Component (LMC). Alternatively, this method may be performed and/or controlled by more than one apparatus, for instance a server cloud comprising at least two servers. Alternatively, the method may for instance be performed and/or controlled by mobile device, e.g. an automated guided vehicle (AGV), and/or an Internet-of-Things (IoT) device, and/or a User Equipment (UE). For instance, the method may be performed and/or controlled by using at least one processor of the LMF, LMC, and/or mobile device.

The mobile communication network may for instance be cellular network. The mobile communication network may for example be a mobile phone network like a 2G/3G/4G/5G/New Radio (NR) and/or future cellular communication network. The 2G/3G/4G/5G/NR cellular radio communication standards are developed by the 3GPP and presently available under http://www.3gpp.org/.

According to a further exemplary aspect of the invention, a computer program is disclosed, the computer program when executed by a processor causing an apparatus, for instance a server, to perform and/or control the actions of the method according to the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect of the invention, an apparatus is disclosed, configured to perform and/or control or comprising respective means for performing and/or controlling the method according to the first exemplary aspect.

The means of the apparatus can be implemented in hardware and/or software. They may comprise for instance at least one processor for executing computer program code for performing the functions, at least one memory storing the program code, or both. Alternatively, they could comprise for instance circuitry that is designed to implement the functions, for instance implemented in a chipset or a chip, like an integrated circuit. In general, the means may comprise for instance one or more processing means or processors.

According to a further exemplary aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the first exemplary aspect.

The above-disclosed apparatus according to any aspect of the invention may be a module or a component for a device, for example a chip. Alternatively, the disclosed apparatus according to any aspect of the invention may be a device, for instance a server or server cloud. The disclosed apparatus according to any aspect of the invention may comprise the disclosed components, for instance means, processor, memory, or may further comprise one or more additional components.

According to a further exemplary aspect of the invention, a system is disclosed, comprising:
at least one mobile device, an automated guided vehicle, AGV, and/or an Internet-of-Things, IoT device; and
at least one LMF, and/or LMC;
wherein the at least one mobile device, AGV, or IoT device and/or the at least one LMF, or LMC are configured to perform the method according to the first exemplary aspect, in particular at least partly jointly.

In the following, exemplary features and exemplary embodiments of all aspects of the present invention will be described in further detail.

Such an apparatus (e.g. a mobile device), as used herein, may for instance be portable (e.g. weigh less than 5, 4, 3, 2, 1 kg, or less), like a mobile phone, personal digital assistance device, computer, laptop computer as a non-limiting examples. The apparatus may for instance comprise or be connectable to a display for displaying information, e.g. a route that is guided/navigated to a user, to name but one non-limiting example. The apparatus may for instance comprise or be connectable to means for outputting sound, e.g. in the form of spoken commands or information. The apparatus may for instance comprise or be connectable to one or more sensors for determining the devices position, such as for instance a GNSS receiver, in the form of a GPS receiver. The apparatus may for instance comprise or be connectable to one or more sensors, e.g. in the form of an accelerometer and/or a gyroscope and/or magnetometer and/or barometer for gathering (e.g. measuring) further information, such as motion sensor data. The barometer may allow for determining the vertical position of the apparatus. The apparatus may for instance comprise or be connectable to a receiver and/or a transmitter (e.g. a transceiver) for receiving and/or sending information. The apparatus may for instance be an AGV, or may be arranged to such an AGV. The AGV may for instance comprise at least two antennas respectively antenna panels, e.g. installed in such a way that they have the pre-defined distance between them. The at least two antennas may for instance be have a distance of 10, 20, 30, 40, 50 cm, or more between them. The at least two antennas may be arranged on the apparatus in such a way that one or more signals (e.g. sent by one or more base stations of a mobile communication network) are observable. The apparatus may for instance be suitable to drive respectively maneuver at least in part autonomously, e.g. in a venue.

The venue may for instance be a building, shopping mall, office complex, public accessible location (e.g. station, airport, university or the like), to name but a few non-limiting examples. The area may for instance be a public place, urban area, rural area, industrial area, or a combination thereof, to name but a few non-limiting examples.

One or more signals sent by one or more base stations e.g. of the mobile communication network may for instance be observable at one or more certain locations within the area and/or venue. Such one or more signals may for instance be observable and/or receivable by the apparatus e.g. being represented by a mobile device, as disclosed above. Such one or more signals may for instance be observable and/or receivable by the apparatus e.g. located within the area and/or venue.

The at least two sets of sample measurements are gathered (e.g. measured), e.g. in case the method is performed by the mobile device. The at least two sets of sample measurements are obtained (e.g. received), e.g. in case the method is performed by the positioning server.

A respective set of sample measurements of the at least two sets of sample measurements is indicative of one or more signals that are observable by an antenna of the at least two antennas. Such a set of sample measurements may for instance be a TOA measurement and/or estimation of the one or more signals that are observable. Additionally or alternatively, a respective TOA estimation may be determined based on, at least in part, a respective set of sample measurements. A respective set of sample measurements of the at least two set of sample measurements is gathered (e.g. measured) by one of the at least two antennas. Thus, in case two sample measurements are gathered or obtained, the first one is measured by a first antenna of the at least two antennas, and the second set of sample measurements is measured by a second antenna of the at least two antennas. In case the apparatus comprises or is connectable to more than two antennas, the respective antennas comprised by or connectable to the apparatus gathers (e.g. measures) a respective sample measurement.

Thus, one set of sample measurements of the at least two sets of sample measurements corresponds to one antenna respectively antenna panel of the at least two antennas respectively antenna panels that are comprised by (e.g. embedded) or connectable to the mobile device. Accordingly, the other set of sample measurements of the at least two sets of sample measurements corresponds to the other antenna respectively antenna panel of the at least two antennas respectively antenna panels. For instance, in case the mobile device comprises or is connectable to more than two antennas or antenna panels, e.g. three antennas or antenna panels, three sets of sample measurements are gathered or obtained, wherein a respective set of the three sets of sample measurements is measured by one certain antenna respectively antenna panel of the three antennas respectively antenna panels. It will be understood that this principle applies accordingly in case the mobile device comprises or is connectable to a plurality of antennas respectively antenna panels so that a corresponding plurality of sets of sample measurements is obtained or gathered.

The apparatus may for instance gather (e.g. measure) a respective set of sample measurements per antenna respective antenna panel of the at least two antennas respectively antenna panels. The at least two sets of sample measurements may be gathered (e.g. measured) based on one or more reference signals sent by one or more base stations (e.g. gNBs) of the mobile communication network. Based on the one or more signals that are observable, a TOA estimation may be determined. Further, to enable the gathering (e.g. measuring), the mobile communication network may provide via one or more respective base stations assistance data enabling the apparatus to gather (e.g. measure) the TOA of the one or more signals sent by the one or more base stations. Before e.g. a determining (e.g. computing) of Reference Signal Time Difference (RSTD), the mobile device may perform a (e.g. sanity) check to analyze whether the (e.g. estimated or determined) TOAs correspond to a same multipath component. This may be done since due to the geometry of the apparatus and thus, the antenna geometry of the at least two antenna comprised by or connectable to the apparatus may have obstructed/attenuated the Line-of-Sight (LoS) component at one or more of the antenna respective antenna panels. After determining of the RSTD, the result may be provided to another entity, e.g. to enable the positioning server to bias the orientation (e.g. orientation estimation), and optionally location (e.g. location estimation) at the LMF and/or LMC.

A respective antenna of the at least two antennas may be comprised by an antenna panel. Alternatively, a respective antenna may be such an antenna panel. Multiple Input Multiple Output (MIMO) is one of the main enabling technologies in e.g. 5G or future communications and is enabled by at least two antennas respective antenna panels, wherein the respective at least two antennas may enable one of the multiple inputs and outputs. A large number of antenna elements may increase data throughput and considerable beamforming gains for improving the coverage. A large number of antenna elements may be assembled into multiple antenna panels for the purpose of cost reduction and power saving. Thus, within the meaning of the present invention, at least two antennas may be part of such an antenna panel, or at least one antenna of the at least two antennas is part of a first antenna panel and the at least one other antenna of the at least two antennas is part of a second antenna panel. In the latter case, the apparatus comprises or is connectable to at least two antenna panels.

The at least two antennas (respectively antenna panels) have at least one pre-defined (e.g. spatial) distance d between them. Thus, at least one antenna is arranged on a first position and at least one other antenna of the at least two antennas is arranged on a second position e.g. of the mobile device. Since the at least two antennas may be fixed and thus not movable along the mobile device, they have a pre-defined distance d between them. The distance may for instance be represented between the center of a respective antenna panel to the other antenna panel, in case of the at least two antennas, as used herein, is represented by a respective antenna panel.

Additionally or alternatively, the distance d between the at least two antennas may be determinable (e.g. derivable) in case the antenna (respectively antenna panel) geometry is known. For instance, in case the center of a first antenna and the center of a second antenna of the at least two antennas is known, the pre-defined distance d may for instance be determined (e.g. calculated). In case the mobile device comprises or is connectable to more than two antennas, a respective pre-defined distance d may be known between possible combination(s) of all antennas comprised by or connectable to the mobile device.

The at least one pre-defined distance and/or the respective distance that the respective at least two antennas are spaced from one another is at least a distance being equal to larger than an accuracy achievable when a location estimate is determined based, at least in part, on the obtained sample measurements.

The TOA difference information is indicative of a TOA difference between the at least two sets of sample measurements. The at least one TOA difference information is determined based, at least in part, on the at least two sets of sample measurements. The determining comprises checking whether the TOA difference reflects the pre-defined distance between the at least two antennas or antenna panels. For instance, in a situation in which at least one of the at least two antennas detects a peak at a largely different delay than the other antenna of the at least two antennas, the at least two antennas panels may determine RSTDs using delays of different channel taps, i.e. LoS at the at least one antenna and non-Los (nLos) at the at least one other antenna of the at least two antennas. A respective channel tap, as used herein, refers to a channel tap is a channel multipath component whose delay is approximated as an integer multiple of the sampling time. For instance, such a channel tap is a tap of tapped delay line, e.g. used for transmitting of the signal that is gathered as a respective sample measurement. Since the difference between the RSTDs from the at least two antennas represented by the at least two sets of sample measurements may not correspond to the time a wave (signal sent by the one or more base stations) would take to travel the physical distance d between the panels, the respective sample measurement(s) of the at least two sets of sample measurements may be refined to not bias the orientation information determining, and optionally the location determining (e.g. estimation) at the positioning server.

An example flow according to example embodiments of all exemplary aspect between a mobile device (e.g. UE) and a positioning server (e.g. LMF and/or LMC) may be as follows:
Step 1: The UE performs independent TOA measurements per antenna or antenna panel, and tests if the difference between TOA estimates per antenna or antenna panel reflect the distance between the antennas or antenna panels
Step 2: if step 1 is fulfilled, then the UE may refine the TOA estimates by, e.g. checking if they correspond to LoS or nLos. In this case, the two TOA estimates are updated jointly.
Step 3: if condition 1 is not fulfilled, then the UE selects as reference the panel with the shortest TOA
Step 4: UE corrects the TOA of the remaining antenna or antenna panel(s) using the reference of step 3. This step involves testing for nLos and application of correction in attenuated LoS conditions. In case of pure nLos, the correction cannot be applied, case in which the UE may tag the respective sample measurement or set of sample measurements with a nLos tag and report (e.g. provide) it as such to the LMF.

In this way, utilizing the geometry of the multiple antenna or antenna panels at the UE and checking the coherency of TOA estimates is enabled. That is, checking whether the difference on the measured TOA estimates match the anticipated TOA difference(s) based on the known relative antenna or antenna panel locations within the apparatus (e.g. mobile device, or e.g. UE). In addition, correcting the measured TOAs accordingly, as described in step 4, after selecting a reference panel is achieved. It is noted that by coherency, it is meant the TOAs across antenna or antenna panels may exhibit a linear dependency, proportional to the panel's geometry, i.e. the relative distances between the combinations of the multiple antenna or antenna panels.

Further, it is enabled to cover in network-based derivations of UE orientation considering the LoS/nLos paths, and allows the UE to report accurate TOA/RSTD estimates that the network may use to determine the orientation represented by a respective orientation information of the mobile device. Orientation determining (e.g. estimation) is enabled. Further, improved positioning accuracy can be provided due to e.g. TOA corrections of the at least two sets of sample measurements and, thus, having an enhanced measurement set (e.g. the at least two sets of sample measurements) gathered by the at least two antennas respectively antenna panels.

According to an exemplary embodiment of the first exemplary aspect, the method further comprises:
obtaining (e.g. receiving in case the apparatus is a LMF/LMC, or retrieving from a memory in case apparatus is a mobile device, to name but a few non-limiting example) at least capability information of the apparatus, wherein the at least capability information is indicative of a number of antennas, the number comprising the at least two antennas, and further indicative of a respective distance that the respective at least two antennas are spaced from one another, and/or further indicative of at least one antenna geometry (e.g. 2D or 3D-geometry) of the at least two antennas,
wherein the TOA difference information is determined based, at least in part, on the at least capability information.

The capability information may for instance be obtained by receiving the capability information from a respective mobile device. Alternatively or additionally, the capability information may for instance be obtained from another entity that is different from the respective mobile device, and that has obtained the respective capability information of the mobile device prior to providing the capability information enabling the apparatus according to the first exemplary aspect to obtain (e.g. receive) the capability information of the mobile device.

For instance, in case the mobile device has three antennas a1, a2 and a3, then the capability information may for instance be indicative of the distances between every combination of the three antennas. Thus, in the example, the capability information may be indicative of the distances d1 (a1, a2); d2 (a1; a3); and d3 (a2; a3).

The obtaining of the at least capability information may for instance involve conveying from the respective mobile device comprising or being connectable to the at least two antennas the geometry of the at least two antennas (respectively antenna panels) and their respective distance(s) from one another. The at least two antennas may be comprised by (e.g. embedded into) the mobile device, or the at least two antennas, or a part of them is connectable to the mobile device in a certain way represented by the geometry. For instance, coordinates of the (e.g. center of) the respective antenna(s) of the at least two antennas may be represented by the geometry. The coordinates may be 2D (e.g. X-, Y-coordinate pair), or 3D (e.g. X-, Y-, Z-coordinates), e.g. in case a respective antenna of the at least two antennas is arranged e.g. in different heights along the mobile device, to name but one non-limiting example.

According to an exemplary embodiment of the first exemplary aspect, the method further comprises:
refining at least one of the at least two sets of sample measurements based, at least in part, on the TOA difference information, wherein the at least one set of sample measurements is refined based, at least in part, on the pre-defined distance between the at least two antennas.

Prior to the refining, it may for instance be checked if the at least two antennas gathered respective sample measurements in nLoS or attenuated LoS (ALoS).

LoS, as used herein, refers to radio signal propagation in which a corresponding radio signal (e.g. one or more electromagnetic waves) travels in a direct path from a source (e.g. one or more base stations of mobile communication network) to a receiver (e.g. apparatus gathering the at least two sets of sample measurements). Such a direct path equals the shortest time-of-flight it takes a respective signal to travel between transceiver (TX) and a receiver (RX). ALoS refers to such a LoS in which, e.g. due to certain obstacles one or more signals are attenuated on their travel from a source to a receiver via the shortest time-of-flight. This may for instance be represented by a LoS criterion indicative of whether or not a respective set of sample measurements was gathered based on signals that travelled on such a direct path (LoS), or that travelled on such a direct path and were subject to a certain attenuation (ALoS).

In contrast, nLoS, as used herein, refers to another radio signal propagation in which a corresponding radio signal does not travel in a direct path from the source to the receiver, but may for instance be reflected by one or more obstacles located between the source and the receiver. Such reflections may happen even multiple times so that the respective signal may be received by the receiver more than one time at with certain delays due to the reflection(s) and the longer path(s) that the respective signal(s) traveled.

The respective set of sample measurements of the at least two sets of sample measurements may be represented by such TOA measurements enabling to determine whether or not an observed signal was propagated by LoS, ALoS or by nLoS. If the respective set of sample measurements is a LoS and/or ALoS, a TOA difference between the at least two sets of sample measurements not corresponding to the pre-defined distance d between the at least two antennas that gathered the at least two sets of sample measurements, and as represented by the determined TOA difference information is indicative of it. Thus, for instance, the attenuated (e.g. erroneous) set of sample measurements may be refined based, at least in part, on the other sample measurement e.g. not being attenuated. For instance, the TOA measurement may be recomputed by e.g. re-estimating relevant channel taps and selecting a subset with (e.g. suitable) delays. If a set sample measurements represents nLoS, the respective TOAs may not be refined, e.g. since a refinement of TOA will not improve the orientation information and/or position estimate determined (e.g. estimated) based on the respective set of sample measurements. In this case, the respective set of sample measurements may be tagged as nLoS, as is disclosed in more detail below.

Such a refining of LoS and/or ALoS sample measurements may for instance be a correction of TOA, TOA correction, performed and/or controlled across the at least two antennas or antenna panels enabling orientation estimation of the apparatus comprising and/or being connectable to the at least two antennas or antenna panels. In this way, the geometry of the at least two antennas or antenna panels at the apparatus (e.g. mobile device) is utilized.

According to an exemplary embodiment of the first exemplary aspect, the at least one set of sample measurements of the at least two sets of sample measurements is refined in case the TOA difference information reflects the pre-defined distance between the at least two antennas.

The TOA difference information may for instance be checked with regard to checking a coherency of TOA estimates e.g. as represented or comprised, at least in part, by each of the at least two sets of sample measurements. It may for instance be checked whether the difference on the measured TOA estimates of the at least two sets of sample measurements match an anticipated TOA difference based on the known relative distance between the at least two antenna (antenna panels), e.g. within the apparatus.

For instance, if the time difference between the TOA estimates at the at least two antennas is smaller than the time a wave takes to travel the distance d between the at least two antennas (antenna panels), then it can be considered that the at least two sets of sample measurements, when gathered (e.g. measured) did observe the same channel tap e.g. of one or more signals sent by one or more base stations. Thus, it can be determined whether the TOA difference information e.g. representing whether or not the time difference between the TOA estimates at the at least two antennas is smaller than the time a wave takes to travel the distance d between the at least two antennas matches the pre-defined distance between the at least two antennas. If the at least two TOAs of the at least two sets of sample measurements correspond to the same channel tap, thus the at least two sets of sample measurements were gathered based on LoS and/or ALoS propagated signal(s), then there is no need for refining at least one of the at least two sets of sample measurements. Otherwise, the at least one of the at least two sets of sample measurements may be refined.

According to an exemplary embodiment of the first exemplary aspect, the method further comprises:
selecting the at least one antenna that gathered the at least one set of sample measurements of the at least two sets of sample measurements comprising or representing a shortest TOA measurement as a reference antenna; and
refining the at least one other set of sample measurements of the at least two sets of sample measurements based, at least in part, on the selected reference antenna, wherein the at least one other set of sample measurements is refined based, at least in part, on the pre-defined distance between the at least two antennas.

If the time difference between the TOA estimates of the at least two sets of sample measurements is larger than d/c (c equals speed of light), it may for instance further be checked, based on the determined TOA difference information, which antenna (or antenna panel) of the at least two antennas (or antenna panels) has observed LoS and/or ALoS propagated signals (e.g. representing a LoS condition) and may refine (e.g. correct) the TOA estimates of the other antenna (or antenna panel). This may be performed and/or controlled conditioned that the antenna (or antenna panel is in attenuated LoS) and not pure nLos so that the respective set of sample measurements is also not observed based on pure nLoS propagated signals.

As a reference, the antenna (or antenna panel) of the at least two antennas (or antenna panels) with the shortest TOA may be selected as a reference. This may for instance be derived based on the at least two sets of sample measurements, wherein one of the at least two sets of sample measurements may for instance represent a shortest TOA estimate in comparison to one or more further sets of sample measurements of the at least two sets of sample measurements.

According to an exemplary embodiment of the first exemplary aspect, at least one respective antenna of the at least two antennas is selected as the reference antenna in case the TOA difference information does not reflect the pre-defined distance between the at least two antennas.

The determining of the at least one antenna of the at least two antennas that gathered the respective set of sample measurements representing the shortest TOA estimate may be done prior to the actual step of the selecting of the respective at least one antenna to be considered as the reference antenna.

According to an exemplary embodiment of the first exemplary aspect, the refining of the at least one set of sample measurements or of the at least one other set of sample measurements further comprises:

checking the at least two sets of sample measurements based, at least in part, on a Line-of-Sight, LoS, criterion indicative of whether the respective set of sample measurements was gathered (e.g. measured) as a LoS, or a non-LoS measurement, wherein the at least one set of sample measurements or of the at least one other set of sample measurements is refined in case the respective set of sample measurements was gathered as a LoS measurement.

In case of pure nLos, the correction cannot be applied, so that e.g. the UE may tag the respective sample measurement with a nLos tag and report it as such to the LMF.

Otherwise, the at least one other sample measurement (e.g. gathered or of the remaining at least one antenna of the at least two antennas) may be refined based, at least in part, on the reference antenna (or reference antenna panel), and/or certain information derivable from the at least capability information e.g. representing the geometry of the at least two antenna used for the gathering of the at least two sets of sample measurements.

According to an exemplary embodiment of the first exemplary aspect, in case the checking is indicative of a non-LoS measurement, the method further comprises:
tagging the respective set of sample measurements as a non-LoS measurement.

For instance, in case all of the sample measurements were subject to a nLoS propagation, the respective set of sample measurements may be tagged as nLos-measurement. In this case, refining the respective sample measurement(s) is not to be made since e.g. a refinement of TOA will not improve the orientation information and/or position estimate to be determined based on such a nLoS sample measurement. The respective sample measurement(s) may be tagged, e.g. by associating the respective sample measurement with, or incorporating into, or marking the respective sample measurement(s) by comprising information indicative of being subject to such a nLoS TOA measurement.

If the respective antenna (or antenna panel) is found to be in pure nLoS, then the corresponding TOA estimate as represented by a respective set of sample measurements of the at least two sets of sample measurements may not be refined and correspondingly, TOA correction may not be applied. Thus, the respective set of sample measurements of the at least two sets of sample measurements may be tagged with a nLoS tag (e.g. a flag) and may be reported as such to a positioning server, in particular the LMF and/or LMC, e.g. which may in example embodiments be the apparatus according to the first exemplary aspect.

According to an exemplary embodiment of the first exemplary aspect, the method further comprises:
providing the at least two sets of sample measurements.

As disclosed above, a respective set of sample measurements e.g. tagged as a nLoS set of sample measurements may be provided (e.g. output) e.g. to be reported to a LMF/LMC of a positioning server, to name but a few non-limiting examples. The respective set of sample measurements may for instance be provided e.g. by sending it from a mobile device e.g. arranged with the at least two antennas and that gathered the at least two sets of sample measurements to another apparatus, e.g. the positioning server. The respective set of sample measurements may for instance be provided by sending it directly e.g. to the positioning server, or by sending it to an entity that is different from the positioning server and which relays the respective set of sample measurements to the positioning server.

According to an exemplary embodiment of the first exemplary aspect, a respective set of sample measurements of the at least two sets of sample measurements is indicative of one or more gathered (e.g. measured) positioning reference signals (PRS), sent by at least one network node (e.g. a base station).

According to an exemplary embodiment of the first exemplary aspect, the method further comprises:

obtaining assistance data for the gathering of the at least two sets of sample measurements, wherein the assistance data enables, at least in part, downlink reference signal measurements, and wherein the at least two sets of sample measurements are gathered based, at least in part, on the obtained assistance data.

The assistance data may for instance be indicative of enabling the apparatus (e.g. mobile device) to gather (e.g. measure) one or more PRS sent by one or more base stations of the mobile communication network. Each antenna of the at least two antennas, or the multiple antennas gathers (e.g. measures) such signals independently to gather the respective sample measurements.

According to an exemplary embodiment of the first exemplary aspect, the apparatus is or is part of a mobile device, an automated guided vehicle, AGV, or an Internet-of-Things, IoT device, or the apparatus is or is part of a location management function, LMF, and/or a location management component, LMC.

Such an AGV may for instance be used in industrial environments. For instance, such a LMF and/or LMC may be part of a (e.g. positioning) server of the mobile communication network, to name but one non-limiting example.

The features and example embodiments of the invention described above may equally pertain to the different aspects according to the present invention.

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 a schematic block diagram of a system according to an exemplary aspect;

FIG. 2 a flowchart showing an example embodiment of a method according to the first exemplary aspect;

FIG. 3 a qualitative representation of a mobile device with (e.g. embedded) two antenna panels;

FIG. 4a, b a respective illustration of a respective TOA estimation of each of the two antenna panels of the mobile device of FIG. 3;

FIG. 5 a TOASC flowchart showing an example embodiment of a method according to the first exemplary aspect; and

FIG. 6 a schematic block diagram of an apparatus configured to perform the method according to the first exemplary aspect.

### DETAILED DESCRIPTION OF SOME EXEMPLARY EMBODIMENTS

The following description serves to deepen the understanding of the present invention and shall be understood to complement and be read together with the description as provided in the above summary section of this specification.

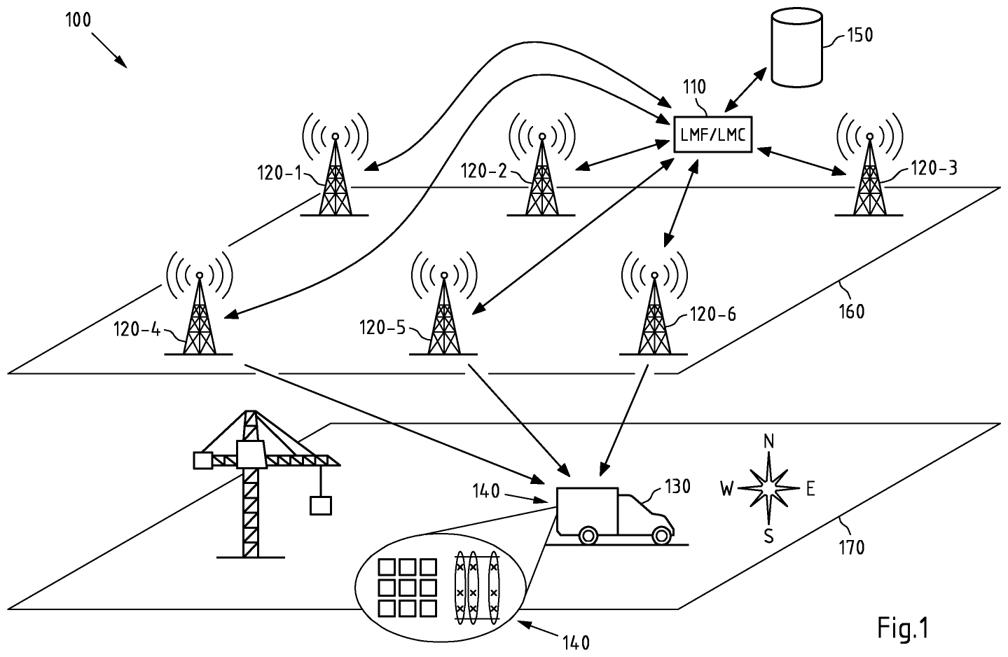

FIG. 1 is an example of a schematic high-level block diagram of a system that is configured to perform and/or control the method according to the first exemplary aspect. The system 100 comprises a positioning server 110 enabling or comprising a LMF and/or a LMC of a mobile communication network. The positioning server may be connectable to or comprise a database 150, e.g. for storing and retrieving information, such as capability information, sample measurements, TOA difference information, or the like, to name but a few non-limiting examples.

The system 100 further comprises a plurality of base stations, at present gNBs 120-1 to 120-6 which signals are observable by the mobile device 130. The base stations 120-1 to 120-6 are part of the mobile communication network. The base stations may provide assistance data for enabling the mobile device 130 to gather PRS that can be measured, at least in part, to gather the respective sample measurements. The base stations are located at or within an (e.g. geographic) area 160.

The mobile device 130 comprises at least two antennas, e.g. that are a part of antenna panel 140. The mobile device is an AGV located in the area 170, in which the signals of the base stations 120-1 to 120-6 are observable, e.g. for determining orientation information indicative of an orientation of the at least two antennas (of the antenna panel 140) respectively of the mobile device 130 in relation to a reference direction. Area 170 may be a part of area 160. Thus, the orientation may be a relative orientation, for instance in relation to a pre-defined reference direction. The reference direction may for instance be a north/south bound direction, or the like, as indicated in FIG. 1 by the illustrated compass. The antenna panel 140 comprises a plurality of antennas that are shown in a detailed view below the mobile device 130. The antenna panel comprises the plurality of antennas that are arranged in a grid, representing a 2D-geometry of the antenna panel. Such a 2D antenna geometry may for instance be represented, at least in part, by capability information associated with the respective mobile device 130.

To enable communication between the mobile device 130, one or more of the base stations 120-1 to 120-6, and/or the positioning server 110, and/or further entities not shown in FIG. 1, the mobile communication network comprising the positioning server 110 and the base stations 120-1 to 120-6 of the system 100 may be used. The mobile communication network may be a cellular (e.g. according to 3G/4G/5G/New Radio or future communication standard) network. Additionally or alternatively, a non-cellular communication network, such as a satellite-based communication network or the Internet may also be utilized to enable communication, to name but a few non-limiting examples. The communication may be wireless as is illustrated in FIG. 1 by the arrows pointing between the base stations 120-1 to 120-6 and the mobile device 130. In FIG. 1, the arrows point towards the mobile device 130 to illustrate that the signals of the base stations 120-1 to 120-6 are observable by the mobile device 130. It will be understood that information may be sent from the mobile device to or via the base stations 120-1 to 120-6 as well. Further communication is illustrated by the arrows pointing between the base stations 120-1 to 120-6 and the positioning server 110.

Example embodiments enabling a method according to the first exemplary aspect may utilize the architecture shown by the system 100 of FIG. 1. The method enables a multi-panel (thus, comprising at least two antennas) mobile device (e.g. UE) correcting one or more TOA estimates from each antenna and/or antenna panel so that the difference between the TOAs reflects the antennas or antenna panels geometry. This characteristic of the measurements is ensured as it is the basis for mobile device (e.g. UE) orientation determining (e.g. estimation), e.g. at the positioning server (e.g. the LMF and/or LMC).

The overall purpose for performing the method according to the first exemplary aspect may be considered to identify whether the measured TOAs correspond to the same multipath component. This is important since otherwise the measurements across different antennas or antenna panels do not reflect the relative position of such antennas to each other, and thus, cannot be used safely for positioning and orientation purposes.

The mobile device may compute and report the TOA/RSTD/other timing metric as observed (e.g. measured) at each of its antennas and/or antenna panels. The positioning server (e.g. LMF and/or LMC) may use such a report (e.g. at least two sets of sample measurements provided to it), together with optional information about the panels placement (e.g. represented by at least capability information) e.g. to infer the mobile device orientation, and optionally location. For the determining (e.g. estimation) to be successful, the mobile device may ensure the relevance of the at least two sets of sample measurements (e.g. TOA) across the at least two antennas respectively antenna panels.

Example embodiments according to all exemplary aspects further enable, a method that tests if the TOAs across panels correspond to the same channel tap, e.g. all panels observe LoS tap. If this is not the case, the mobile device (e.g. UE) may be needed to correct the TOA estimates (e.g. represented or comprised by the at least two sets of sample measurements) prior to providing (e.g. reporting) them to the positioning server (e.g. LMF and/or LMC).

The mobile device (e.g. UE) may be equipped with one RF chain per antenna respectively antenna panel and observes (e.g. listens) for PRS for a period T seconds. If the processing delay associated with one TOA estimation is Δt_{process}, then the mobile device (e.g. UE) can send an RSTD report back no sooner than T+2Δt_{process}. In case that both panels are connected to the same RF chain, then the mobile device (e.g. UE) sequentially listens for PRS with the respective antenna respectively antenna panel e.g. comprised by or connectable to the mobile device (e.g. UE). In such situation, the listening time doubles to 2T and the UE needs δt_{switch} seconds to switch between panels. That yields a total latency of 2T+2Δt_{process}+δt_{switch}. It is ensured that the total latency is smaller than the response time of the LMF and/or LMC.

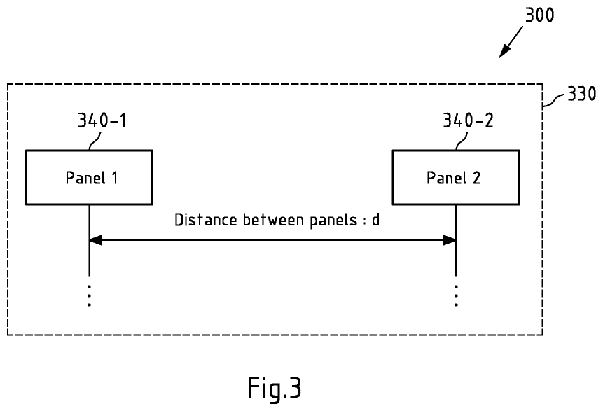

Without loss of generality, in the following example embodiment of all exemplary aspects, it is assumed that the UE 300 has two antenna panels 340-1 and 340-2 as depicted in FIG. 3. An extension to multiple panels can follow similarly.

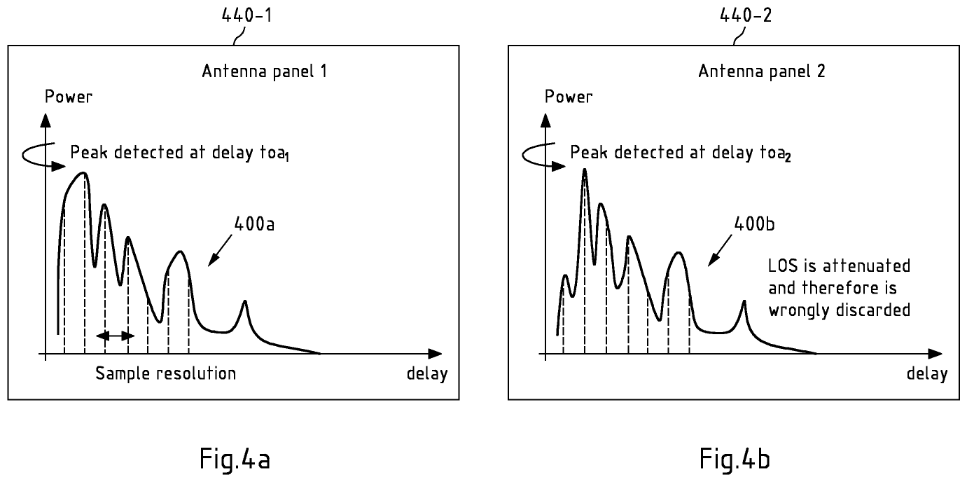

The apparatus (e.g. UE 300) measures one TOA per antenna panel 340-1 and 340-2. The measured TOAs are shown in FIGS. 4a and 4b, wherein in FIG. 4a, the respective TOA 400a gathered (e.g. measured) by antenna panel 340-1 is shown, and in FIG. 4b, the respective TOA 400b gathered (e.g. measured) by antenna panel 340-2 is shown. To further illustrate the relation between FIG. 3 and FIGS. 4a and 4b, the antenna panel 440-1 corresponds to antenna panel 340-1 of FIG. 3, and the antenna panel 440-2 corresponds to the antenna panel 340-2 shown in FIG. 3.

Before determining the TOA difference information, e.g. gathering of a respective sets of sample measurements needs to take place, e.g. and computing RSTD(s) may be done by the antenna panels 340-1 and 340-2. Then, the TOA difference information between the at least two sets of sample measurements may be determined. Before the determining, the UE 300 may perform a sanity check to test whether the estimated TOAs as represented by the at least two sets of sample measurements correspond to the same multipath component (e.g. since the UE 300 antenna geometry may have obstructed/attenuated the LoS component at one of the antennas or antenna panels 340-1, 340-2). In FIG. 4b, it is depicted the situation (represented by the graph 400b) in which antenna panel 340-2 detects a peak at a largely different delay than the one at antenna panel 340-1, as depicted in FIG. 4a by the graph 400a. In such a situation, the two antenna panels 340-1 and 340-2 have gathered signals and e.g. determined (e.g. computed) RSTDs using delays of different channel taps, i.e. LoS at antenna panel 340-1 and nLos at antenna panel 340-22. The respective set of sample measurements representing the respective RSTD will subsequently bias the location and orientation estimation at the LMF and/or LMC, since the difference between the RSTDs from the two antenna panels 340-1 and 340-2 does not correspond to the time a wave would take to travel the physical distance d between the antenna panels 340-1 and 340-2, see also FIG. 3.

To check the validity of the sample measurements e.g. representing TOA estimates, according to example embodiments of all exemplary aspects, the method may be for performing and/or controlling a TOA-Sanity Check (TOASC). The method may comprise the following:
if the TOA difference information representing e.g. time difference(s) between the TOAs at the two antenna panels (e.g. antenna panels 340-1 and 340-2 of FIG. 3) is smaller than the time a wave takes to travel distance d between the antenna panels, then it may be considered that both antenna panels have observed the same channel tap.
   The UE may check if the two TOAs correspond to LoS and if not, it may refine (e.g. correct) these TOA estimates.
   Subsequently, the UE may determine (e.g. compute) the RSTDs.
if the time difference between the TOAs is larger than d/c, the UE may check which antenna panel of the antenna panels comprised by or connectable to the UE has observed (e.g. sees) LoS conditions and corrects the TOA of the respective other antenna panel, conditioned that the antenna panel is in attenuated LoS and not pure nLos.
   if the respective antenna panel is found to be in pure nLos, then the corresponding TOA cannot be corrected.
   in such a case, the UE may still report both RSTDs, but additionally tag the measurement of the respective antenna panel as nLos. This tagging can be used by the LMF and/or LMC as an RSTD uncertainty metric.

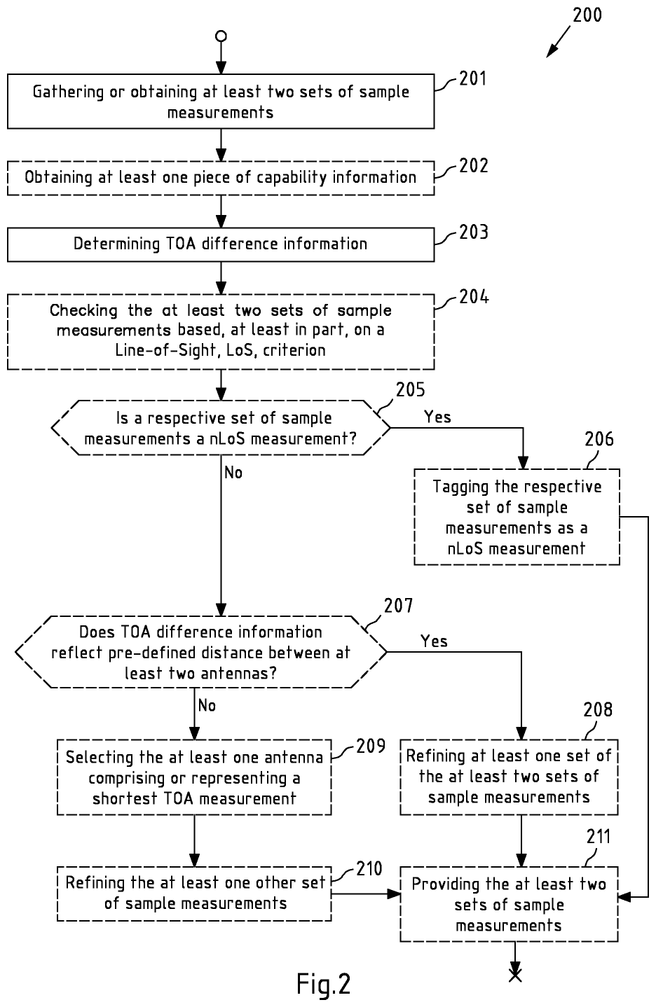

FIG. 2 is a flowchart 200 showing an example embodiment of a method according to the first exemplary aspect of the present invention. This flowchart 200 may for instance be performed by a positioning server, in particular a LMF and/or LMC, e.g. 110 of FIG. 1. Alternatively, the flowchart 200 may for instance be performed by a mobile device, e.g. mobile device 130 of FIG. 1. Alternatively, the flowchart 200 may for instance be performed by such a positioning server and by at least one of such a mobile device together.

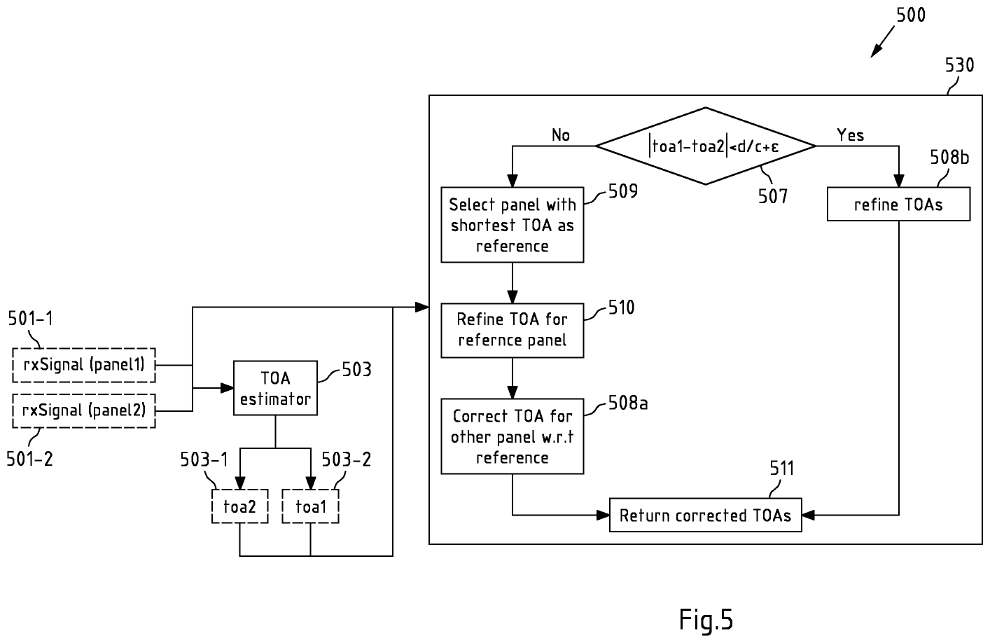

In a first step 201, at least two sets of sample measurements are gathered or obtained. The at least two sets of sample measurements may be obtained from a mobile device, e.g. mobile device 130 of FIG. 1. The mobile device may have gathered the at least two sets of sample measurements with a respective antenna of at least two antennas comprised (e.g. embedded) or connectable to (e.g. arranged on) the mobile device. The at least two sets of sample measurements may then be provided from the mobile device to a positioning server, in particular a LMF and/or LMC 110 of FIG. 1. The LMF and/or LMC, thus, obtains (e.g. receives) the at least two sets of sample measurements. Prior to providing the at least two sets of sample measurements, e.g. via a TOA estimator (see e.g. TOA estimator 503 of FIG. 5), respective TOAs for the respective sample measurements that is gathered may be determined (e.g. estimated). Such a respective TOA may for instance be comprised, at least in part, by the respective set of sample measurements.

In an optional second step 202, at least capability information may for instance be obtained, e.g. by retrieving the at least capability information from a memory (e.g. in case step 202 is performed by mobile device 130 of FIG. 1), or it may be received by the LMF and/or LMC 110 of FIG. 1 (e.g. from the mobile device 130 of FIG. 1), or retrieved from a database (e.g. database 150 of FIG. 1 in which the at least capability information was stored prior to the retrieving).

From the at least capability information, the pre-defined distance between the at least two antennas may be known or derived from a respective antenna geometry represented by at least capability information. As an example, based on the at least capability information, in a third step 203, the TOA difference information between the TOAs of the sample measurements may be determined.

In an optional forth step 204, it may be checked whether the at least two sets of sample measurements fulfil a LoS criterion. Such a LoS criterion may for instance be indicative of whether or not the sample measurements were gathered based on signals of the same channel tap, or are subject to attenuation, to name but a few non-limiting examples. In particular, such a check may show whether a respective set of sample measurements gathered by the respective different antennas was gathered based on ALoS or nLoS propagated signals, which may yield to reduced accuracy of orientation determining of the mobile device, in case such an orientation determining is performed and/or controlled for the respective mobile device.

In a fifth step 205, it is checked whether a respective set of sample measurements of step 201 is such a nLos measurement. In case at least one of the sample measurements is a nLos measurement, flowchart 200 continues with step 206. Since such a set of sample measurements may not sensible to be refined, it is tagged in a sixth step 206 by tagging or marking the respective sample measurement as a nLoS measurement. The tagged sample measurement (or a plurality of such sample measurements) may be provided, e.g. to be utilized for orientation determining. This may also be done by the LMF and/or LMC. In case the flowchart is performed and/or controlled by the mobile device, the tagged sample measurement(s) may for instance be provided to the LMF and/or LMC.

If, however, a respective set of sample measurements is not subject to nLoS propagated signals, in a seventh step 207, it is checked whether the difference e.g. in the TOAs as represented by the sample measurements reflects the pre-defined (physical) distance d between the at least two antennas that were used to gather the at least two sets of sample measurements. If the TOA difference information corresponds to the distance d, in an optional eights step 208 the at least one sample measurement may be refined, e.g. by updating the respective set of sample measurements jointly to offset (e.g. potential) bias resulting from the distance between the at least two antennas. For instance, in case the respective sample measurements are ALoS, they are refined based on the other set of sample measurement that are LoS measurements.

If, however, a respective set of sample measurements is subject to nLoS propagated signals, then in a ninth step 209, the respective set of sample measurements representing the shortest TOA, respectively the antenna that was used to gather the respective set sample measurements, is selected as a reference, e.g. so that at least one set of sample measurements is refined (step 210) based on the reference antenna so that the respective sample measurements provide comparable information offsetting (e.g. potential) influence on the set of sample measurements resulting from nLoS signals. In this way, enhanced accuracy of position determining and/or of orientation determining of the mobile device is achieved, to name but one non-limiting example.

In an optional eleventh step 211, the at least two set of sample measurements are provided, e.g. by outputting them to be utilized in further positioning- and/or orientation-based services of the mobile communication network.

It will be understood that at least some of the steps 201 to 211 may for instance be performed and/or controlled by different entities. For instance, all of the steps 201 to 211 may be performed by one or more mobile device, e.g. as represented by the mobile device 130 of FIG. 1. Further, e.g. step 201 may be may be performed by one or more mobile device, and after the at least two sets of sample measurements are provided, a respective positioning server, e.g. LMF and/or LMC 110 of FIG. 1 may perform and/or control one or more of the steps 202 to 210. Then, in the step 211 the at least two sets of sample measurements may be provided to a positioning server, e.g. LMF and/or LMC 110 of FIG. 1. In addition or in the alternative, steps 201 to 211 may for instance be performed and/or controlled by a positioning server, e.g. LMF and/or LMC 110 of FIG. 1. Optionally, also step 211 may be performed and/or controlled by the LMF and/or LMC, e.g. to provide the at least two sets of sample measurements refined respectively corrected as proposed by example embodiments of all exemplary aspects accordingly for further applications.

To accommodate other antenna geometries, e.g. of three or more antennas respectively antenna panels, the sample measurements of at least two antennas may be used at a time and the flowchart 200 may be performed and/or controlled repetitively until all or some of the antenna-combinations are considered.

Also, beamforming on part of the mobile device, e.g. mobile device 140 of FIG. 1 is possible. The method according to the first exemplary aspect could benefit from the use of such beams. For instance, in a first instance, wide-beam for the antennas respectively antenna panels may be used to gather a respective set of sample measurements. Then a narrower beam may be used on the antennas respectively antenna panels enabling to further enhance the accuracy, e.g. of orientation determining of the mobile device since e.g. the orientation of the beams with regard to the antennas respectively antenna panels is known. This may be comprised by the at least capability information, to name but one non-limiting example.

The d/c+c (see e.g. block 507 of FIG. 5) may be adjusted corresponding to a radio coupling between the antenna respectively antenna panels. Also, the actual radiation pattern may also be considered e.g. by adjusting the “d/c+c” value accordingly.

FIG. 5 is a TOASC, TOA Sanity Check, flowchart 500 showing an example embodiment of a method according to the first exemplary aspect. The method may be used e.g. corresponding to the method shown in the flowchart 200 of FIG. 2, e.g. for the above disclosed TOA Sanity Check, to name but one non-limiting example. As a respective input, the respective sample measurements may be obtained (e.g. received), comprising one or more of the following:
TOA estimates per antenna panel e.g. from an existing “TOA” estimator block.
Received signal at a respective antenna or antenna panel.

The decision block of the branch 530 checks whether the TOAs correspond to the same channel tap, corresponding to step 204 of FIG. 2. Further, it may be checked whether the TOAs reflect the pre-defined distance respectively antenna geometry of the at least two antennas used for the gathering of the sample measurements, see also step 207 of FIG. 2. The deviation c is a permissible error and can be set to a fraction of d/c.

The “yes” branch of the output of the decision block 507 deals with the case in which both antenna panels observe the same path, thus, e.g. the at least two sets of sample measurements are LoS measurements (see also step 205 of FIG. 2). Further, TOASC can ensure that the path is LoS and if not, to correct it. The “no” branch describes the operation flow for the latter case in which the delays correspond to different paths at the different antennas or antenna panels, in which the antenna panel is selected with shortest TOA as reference (509, also see step 209 of FIG. 2), the TOA is refined based on the reference antenna panel (510, also see step 210 of FIG. 2), and TOA is corrected (e.g. refined) for other antenna panel (508, also see step 208 of FIG. 2). Then, in particular the refined (e.g. corrected) TOAs are returned (e.g. provided). Additionally, also the TOAs, or the respective sample measurements representing such TOAs may be provided (511, also see step 211 of FIG. 2).

The branch with the blocks 501-1, 501-2, 503, 503-1, and 503-2 shows the gathering of the sample measurements, e.g. used as an input for the branch 530. For the antenna panel that may be comprised by a mobile device, the signals that are observable are gathered (illustrated by block 501-1 “rxSignal(panel 1)”, and block 501-2 “rxSignal(panel 2)”). The sample measurements can be provided optionally to a TOA estimator (block 503) to determine (e.g. estimate or derive) from the gathered sample measurements the respective TOAs. Alternatively, the respective TOAs may be comprised by f the respective sample measurements in case they are obtained or gathered (see step 201 of FIG. 1). As a respective output, the TOA estimator may provide the determined TOAs determined based on a respective sample measurement, referred to as “toa2” and “toa1” of blocks 503-1 and 503-2.

Implementation details for the operations of both branches (see function TOASC, and function refineTOA) shown in FIG. 5 may be described as presented in the following pseudocode. Elements after the %-sign are descriptive for the functionality of the routine following immediately after the description.

function TOASC(rxSignal, toa1, toa2)

if (|toa1-toa2|<=d/c)

% panels see same channel tap

correctedTOA = refineTOA(rxSignal, toa1, toa2)

elseif

% antenna panels see different channels
% panel with shortest TOA is selected as reference
refPanelTOA = selectPanelwithShortestTOA(toa1, toa2)
% ensure reference panel sees LOS
correctedRefPanelTOA = refineTOA(refPanelTOA)
% correct remaining panel w.r.t. reference panel
correctedOtherPanelTOA = correctTOArelativeToRef(correctedRefPanelTOA,
toa2,rxSignal)
correctedTOA = [correctedRefPanelTOA correctedOtherPanelTOA]

endif
return correctedTOA

function refineTOA( )

% check if LOS and correct if not
LOSperPanel = LOSdetection(rxSignal)
%correct toa if LOSperPanel indicates attenuated LOS conditions
correctedTOA = correctTOA(LOSperPanel, rxSignal)

return correctedTOA

The routine refineTOA( ) checks if the antennas or antenna panels are in nLos or attenuated in LoS. If LoS is attenuated, then the TOA is recomputed by e.g. re-estimating relevant channel taps and selecting a subset with delays. If both antennas or antenna panels are in nLos, their TOAs cannot be corrected. In this case, the measurement is tagged as NLOS and reported as is to the LMF.

The routine LOSdetection( ) may use estimated power delay profile (PDP) to detect whether the LoS is completely obstructed, or attenuated. This can be achieved by rule-based methods that compare various PDP-related metrics to empiric thresholds, or alternatively feeding these metrics to classifiers from a machine learning framework, to name but one non-limiting example.

The routine correctedTOAQis called after LOS detection has been performed. Depending on the output of the LOS detection, the correction may:
Refine peak around estimated TOA with e.g. binned delay detection, if LOS=1
Choose the earliest relevant peak (i.e peak with Power>a % MaxPower), if ALOS=1
Return TOA with variance=inf (infinite) (or other large value) to signify that result trust is very low, if LOS=0.

In this way, it is enabled to determine orientation information (e.g. orientation estimation). Further, it is enabled to improve positioning accuracy due to TOA corrections and enhanced measurement set from multiple UE antennas.

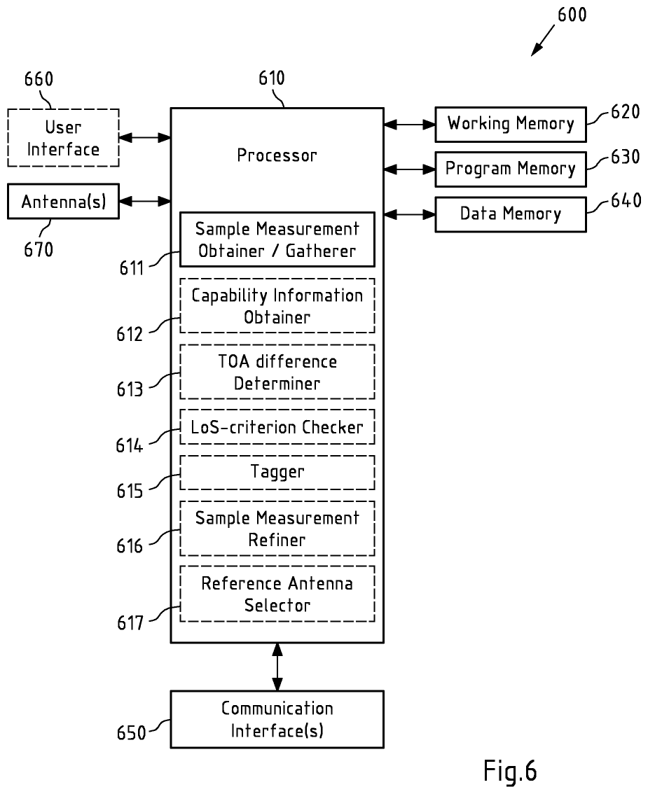

FIG. 6 is a schematic block diagram of an apparatus 600 according to an exemplary aspect of the present invention, which may for instance represent the positioning server 110 of FIG. 1. Alternatively, the schematic block diagram of the apparatus 300 according to an exemplary aspect of the present invention may for instance represent the mobile device 130 of FIG. 1.

Apparatus 600 comprises a processor 610, working memory 620, program memory 630, data memory 640, communication interface(s) 650, an optional user interface 660 and at least two antennas 670. The at least two antennas may be part of an antenna panel. Also, at least two of such antenna panels may be comprised by or connectable to the apparatus 600.

Apparatus 600 may for instance be configured to perform and/or control or comprise respective means (at least one of 610 to 670) for performing and/or controlling the method according to the first exemplary aspect. Apparatus 600 may as well constitute an apparatus comprising at least one processor (610) and at least one memory (620) including computer program code, the at least one memory and the computer program code configured to, with the at least one processor, cause an apparatus, e.g. apparatus 600 at least to perform and/or control the method according to the first exemplary aspect.

Processor 610 may for instance comprise a sample measurement obtainer/gatherer 611 as a functional and/or structural unit. Sample measurement obtainer/gatherer 611 may for instance be configured to obtain (e.g. receive or retrieve from a memory, e.g. data memory 640) one or more sample measurements or sets of sample measurements (see step 201 of FIG. 2).

Processor 610 may for instance comprise an optional capability information obtainer 612 as a functional and/or structural unit. Capability information obtainer 611 may for instance be configured to obtain (e.g. receive or retrieve from a memory, e.g. data memory 640) capability information (see step 202 of FIG. 2).

Processor 610 may for instance comprise an optional TOA difference determiner 613 as a functional and/or structural unit. TOA difference determiner 613 may for instance be configured to determine TOA difference information, e.g. based, at least in part, on the sample measurements (see step 203 of FIG. 2).

Processor 610 may for instance comprise an optional LoS-criterion checker 614 as a functional and/or structural unit. LoS-criterion checker 614 may for instance be configured to check whether or not a respective set of sample measurements was gathered based on a LoS, ALoSor a nLoS TOA measurement (see step 204/205 of FIG. 2).

Processor 610 may for instance comprise an optional tagger 615 as a functional and/or structural unit. Tagger 615 may for instance be configured to tag a respective sample measurement or a set of sample measurements as a nLoS TOA measurement (e.g. in case a respective sample measurement or set of sample measurements is determined to be such a nLoS TOA measurement by LoS-criterion checker 615; see step 206 of FIG. 2).

Processor 610 may for instance comprise an optional sample measurement refiner 616 as a functional and/or structural unit. Sample measurement refiner 616 may for instance be configured to refine a respective set of sample measurements gathered or obtained by the sample measurement obtainer/gatherer 611) (see step 208/210 of FIG. 2).

Processor 610 may for instance comprise an optional reference antenna selector 617 as a functional and/or structural unit. Reference antenna selector 617 may for instance be configured to select a reference antenna of at least two antennas that gathered and/or obtained the sample measurements (e.g. by sample measurement obtainer/gatherer 611; see step 209 of FIG. 2).

Processor 610 may for instance further control the memories 620 to 640, the communication interface(s) 650, the optional user interface 660 and the antennas 670.

Processor 610 may for instance execute computer program code stored in program memory 630, which may for instance represent a computer readable storage medium comprising program code that, when executed by processor 610, causes the processor 610 to perform the method according to the first exemplary aspect.

Processor 610 (and also any other processor mentioned in this specification) may be a processor of any suitable type. Processor 610 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 610 may for instance be an application processor that runs an operating system.

Program memory 630 may also be included into processor 610. This memory may for instance be fixedly connected to processor 610, or be at least partially removable from processor 610, for instance in the form of a memory card or stick. Program memory 630 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 630 may also comprise an operating system for processor 610. Program memory 630 may also comprise a firmware for apparatus 600.

Apparatus 600 comprises a working memory 620, for instance in the form of a volatile memory. It may for instance be a Random Access Memory (RAM) or Dynamic RAM (DRAM), to give but a few non-limiting examples. It may for instance be used by processor 610 when executing an operating system and/or computer program.

Data memory 640 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 640 may for instance store information, such as capability information, sample measurements, TOA difference information, or the like, to name but a few non-limiting examples.

Communication interface(s) 650 enable apparatus 600 to communicate with other entities, e.g. of system 100 of FIG. 1. The communication interface(s) 650 may for instance comprise a wireless interface, e.g. a cellular radio communication interface and/or a WLAN interface and/or wire-bound interface, e.g. an IP-based interface, for instance to communicate with entities via the Internet. Communication interface(s) may enable apparatus 600 to communicate with other entities e.g. not shown in FIG. 1.

User interface 660 is optional and may comprise a display for displaying information to a user and/or an input device (e.g. a keyboard, keypad, touchpad, mouse, and/or control device for maneuvering the apparatus in case it is an AGV, etc.) for receiving information from a user.

Some or all of the components of the apparatus 600 may for instance be connected via a bus. Some or all of the components of the apparatus 600 may for instance be combined into one or more modules.

The following embodiments shall also be considered to be disclosed:

### Embodiment 1

Apparatus comprising means for performing:
gathering at least two sets of sample measurements, wherein a respective set of sample measurements of the at least two sets of sample measurements is indicative of one or more signals that are observable by an antenna, wherein a respective set of sample measurements of the at least two sets of sample measurements is measured with a respective antenna of at least two antennas, and wherein the at least two antennas have at least one pre-defined distance from one another and are comprised by or connectable to the apparatus;
determining time-of-arrival, TOA, difference information indicative of a TOA difference between the at least two sets of sample measurements, wherein the at least one TOA difference information is determined based, at least in part, on at least two sets of sample measurements, wherein the determining comprises checking whether the TOA difference reflects the pre-defined distance between the at least two antennas.

### Embodiment 2

The apparatus according to embodiment 1, wherein the means are further configured to perform:
obtaining at least capability information of the apparatus, wherein the at least capability information is indicative of a number of antennas, the number comprising the at least two antennas, and further indicative of a respective distance that the respective at least two antennas are spaced from one another, and/or further indicative of at least one antenna geometry of the at least two antennas, wherein the TOA difference information is determined based, at least in part, on the at least capability information.

### Embodiment 3

The apparatus according to any of the preceding embodiments, wherein the means are further configured to perform:
refining at least one of the at least two sets of sample measurements based, at least in part, on the TOA difference information, wherein the at least one set of sample measurements is refined based, at least in part, on the pre-defined distance between the at least two antennas.

### Embodiment 4

The apparatus according to any of the preceding embodiments, wherein the at least one set of sample measurements of the at least two sets of sample measurements is refined in case the TOA difference information reflects the pre-defined distance between the at least two antennas.

### Embodiment 5

The apparatus according to any of the preceding embodiments, wherein the means are further configured to perform:
selecting the at least one antenna that gathered the at least one set of sample measurements of the at least two sets of sample measurements comprising or representing a shortest TOA measurement as a reference antenna; and
refining the at least one other set of sample measurements of the at least two sets of sample measurements based, at least in part, on the selected reference antenna, wherein the at least one other set of sample measurements is refined based, at least in part, on the pre-defined distance between the at least two antennas.

### Embodiment 6

The apparatus according to any of the preceding embodiments, wherein at least one respective antenna of the at least two antennas is selected as the reference antenna in case the TOA difference information does not reflect the pre-defined distance between the at least two antennas.

### Embodiment 7

The apparatus according to any of the preceding embodiments, wherein the means for refining of the at least one set of sample measurements or of the at least one other set of sample measurements further comprises:
checking the at least two sets of sample measurements based, at least in part, on a Line-of-Sight, LoS, criterion indicative of whether the respective set of sample measurements was gathered as a LoS, or a non-LoS measurement,
wherein the at least one set of sample measurements or the at least one other set of sample measurements is refined in case the respective set of sample measurements was gathered as a LoS measurement.

### Embodiment 8

The apparatus according to any of the preceding embodiments, wherein the means are further configured to perform:
in case the checking is indicative of a non-LoS measurement:
tagging the respective set of sample measurements as a non-LoS measurement.

### Embodiment 9

The apparatus according to any of the preceding embodiments, wherein the means are further configured to perform:
providing the at least two sets of sample measurement.

### Embodiment 10

The apparatus according to any of the preceding embodiments, wherein a respective set of sample measurements of the at least two sets of sample measurements is indicative of one or more gathered positioning reference signals sent by at least one network node.

### Embodiment 11

The apparatus according to any of the preceding embodiments, wherein the apparatus is or is part of a mobile device, an automated guided vehicle, AGV, or an Internet-of-Things, IoT device, or the apparatus is or is part of a location management function, LMF, and/or a location management component, LMC.

### Embodiment 12

The apparatus of any preceding embodiments, wherein the means comprises

at least one processor; and

at least one memory including computer program code, the at least one memory and computer program code configured to, with the at least one processor, cause the performance of the apparatus.

### Embodiment 13

A method, comprising:
gathering at least sets of two sample measurements, wherein a respective set of sample measurement of the at least two sets of sample measurements is indicative of one or more signals that are observable by an antenna, wherein a respective set of sample measurement of the at least two sets of sample measurements is measured with a respective antenna of at least two antennas, and wherein the at least two antennas have at least one pre-defined distance from one another and are comprised by or connectable to the apparatus;
determining time-of-arrival, TOA, difference information indicative of a TOA difference between the at least two sets of sample measurements, wherein the at least one TOA difference information is determined based, at least in part, on at least two sets of sample measurements, wherein the determining comprises checking whether the TOA difference reflects the pre-defined distance between the at least two antennas.

### Embodiment 14

The method according to embodiment 13, further comprising:
obtaining at least capability information of the apparatus, wherein the at least capability information is indicative of a number of antennas, the number comprising the at least two antennas, and further indicative of a respective distance that the respective at least two antennas are spaced from one another, and/or further indicative of at least one antenna geometry of the at least two antennas,
wherein the TOA difference information is determined based, at least in part, on the at least capability information.

### Embodiment 15

The method according to embodiment 13 or 14, further comprising:
refining at least one set of the at least two sets sample measurements based, at least in part, on the TOA difference information, wherein the at least one set of sample measurements is refined based, at least in part, on the pre-defined distance between the at least two antennas.

### Embodiment 16

The method according to embodiment 15, wherein the at least one set of sample measurements of the at least two sets of sample measurements is refined in case the TOA difference information reflects the pre-defined distance between the at least two antennas.

### Embodiment 17

The method according to any of the embodiments 13 to 16, further comprising:
selecting the at least one antenna that gathered the at least one set of sample measurements of the at least two sets of sample measurements comprising or representing a shortest TOA measurement as a reference antenna; and
refining the at least one other set of sample measurements of the at least two sets of sample measurements based, at least in part, on the selected reference antenna, wherein the at least one other set of sample measurements is refined based, at least in part, on the pre-defined distance between the at least two antennas.

### Embodiment 18

The method according to embodiment 17, wherein at least one respective antenna of the at least two antennas is selected as the reference antenna in case the TOA difference information does not reflect the pre-defined distance between the at least two antennas.

### Embodiment 19

The method according to any of the embodiments 13 to 18, wherein the refining of the at least one set of sample measurements and/or of the at least one other set of sample measurements further comprises:
checking the at least two sets of sample measurements based, at least in part, on a Line-of-Sight, LoS, criterion indicative of whether the respective set of sample measurements was gathered as a LoS, or a non-LoS measurement,
wherein the at least one set of sample measurements and/or the at least one other set of sample measurements is refined in case the respective sample measurement was gathered as a LoS measurement.

### Embodiment 20

The method according to embodiment 19, further comprising in case the checking is indicative of a non-LoS measurement:
tagging the respective set of sample measurements as a non-LoS measurement.

### Embodiment 21

The method according to any of the embodiments 13 to 20, the computer program code when executed by a processor causing an apparatus to perform and/or control:
providing the at least two sets of sample measurement.

### Embodiment 22

The method according to any of the embodiments 13 to 21, wherein a respective set of sample measurements of the at least two sets of sample measurements is indicative of one or more gathered positioning reference signals sent by at least one network node.

### Embodiment 23

A tangible computer-readable medium storing computer program code, the computer program code when executed by a processor causing an apparatus to perform and/or control:
gathering at least two sets of sample measurements, wherein a respective set of sample measurements of the at least two sets of sample measurements is indicative of one or more signals that are observable by an antenna, wherein a respective set of sample measurements of the at least two sets of sample measurements is measured with a respective antenna of at least two antennas, and wherein the at least two antennas have at least one pre-defined distance from one another and are comprised by or connectable to the apparatus;
determining time-of-arrival, TOA, difference information indicative of a TOA difference between the at least two sets of sample measurements, wherein the at least one TOA difference information is determined based, at least in part, on at least two sets of sample measurements, wherein the determining comprises checking whether the TOA difference reflects the pre-defined distance between the at least two antennas.

### Embodiment 24

The tangible computer-readable medium according to embodiment 23, the computer program code when executed by a processor causing an apparatus to perform and/or control:
obtaining at least capability information of the apparatus, wherein the at least capability information is indicative of a number of antennas, the number comprising the at least two antennas, and further indicative of a respective distance that the respective at least two antennas are spaced from one another, and/or further indicative of at least one antenna geometry of the at least two antennas,
wherein the TOA difference information is determined based, at least in part, on the at least capability information.

### Embodiment 25

The tangible computer-readable medium according to embodiment 23 or embodiment 24, the computer program code when executed by a processor causing an apparatus to perform and/or control:
refining at least one of the at least two sets of sample measurements based, at least in part, on the TOA difference information, wherein the at least one set of sample measurements is refined based, at least in part, on the pre-defined distance between the at least two antennas.

### Embodiment 26

The tangible computer-readable medium according to embodiments 23 to 26, wherein the at least one set of sample measurements of the at least two sets of sample measurements is refined in case the TOA difference information reflects the pre-defined distance between the at least two antennas.

### Embodiment 27

The tangible computer-readable medium according to any of the embodiments 23 to 26, the computer program code when executed by a processor causing an apparatus to perform and/or control:
selecting the at least one antenna that gathered the at least one set of sample measurements of the at least two sets of sample measurements comprising or representing a shortest TOA measurement as a reference antenna; and
refining the at least one other set of sample measurements of the at least two sets of sample measurements based, at least in part, on the selected reference antenna, wherein the at least one other set of sample measurements is refined based, at least in part, on the pre-defined distance between the at least two antennas.

### Embodiment 28

The tangible computer-readable medium according to embodiments 23 to 27, wherein at least one respective antenna of the at least two antennas is selected as the reference antenna in case the TOA difference information does not reflect the pre-defined distance between the at least two antennas.

### Embodiment 29

The tangible computer-readable medium according to embodiments 23 to 28, wherein the refining of the at least one set of sample measurements or of the at least one other set of sample measurements further comprises:
checking the at least two sets of sample measurements based, at least in part, on a Line-of-Sight, LoS, criterion indicative of whether the respective set of sample measurements was gathered as a LoS, or a non-LoS measurement,
wherein the at least one set of sample measurements or the at least one other set of sample measurements is refined in case the respective set of sample measurements was gathered as a LoS measurement.

### Embodiment 30

The tangible computer-readable medium according to any of the embodiments 23 to 29, the computer program code when executed by a processor causing an apparatus to perform and/or control in case the checking is indicative of a non-LoS measurement:
tagging the respective set of sample measurements as a non-LoS measurement.

### Embodiment 31

The tangible computer-readable medium according to any of the embodiments 23 to 30, the computer program code when executed by a processor causing an apparatus to perform and/or control:
providing the at least two sets of sample measurement.

### Embodiment 32

The tangible computer-readable medium according to embodiments 23 to 31, wherein a respective set of sample measurements of the at least two sets of sample measurements is indicative of one or more gathered positioning reference signals sent by at least one network node.

### Embodiment 33

An apparatus comprising at least one processor and at least one memory including computer program code, the at least one memory and the computer program code configured to, with the at least one processor, cause an apparatus at least to perform and/or control the method of the first exemplary aspect.

Example embodiments may thus be utilized to enable enhancements and solutions necessary to support high accuracy (e.g. horizontal and/or vertical), low latency, network efficiency (scalability, RS overhead, etc.) and device efficiency (power consumption, complexity) requirements for commercial uses cases (including general commercial use cases and specifically (I) IoT use cases. In particular, example embodiments according to all exemplary aspects enable a mechanism for determine a UE's heading (represented by a respective orientation information) with an accuracy better than 30 degrees (0.54 rad) and a positioning service availability of 99.9% for static users and with an accuracy better than 10 degrees (0.17 rad) and a positioning service availability of 99% for users up to 10 km/h.”

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are exemplary, and that any feature presented for a particular example embodiment may be used with any aspect of the invention on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature of the invention and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of one of the enumerated features is possible. The specific combination of all subsequently enumerated features may as well be considered. Also, a plurality of one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The invention has been described above by means of example embodiments. It should be noted that there are alternative ways and variations which are obvious to a skilled person in the art and can be implemented without deviating from the scope of the appended claims.

1. An apparatus comprising at least one processor and at least one memory including computer program code, the at least one memory and the computer program code configured to, with the at least one processor, cause the apparatus to at least perform:
gathering at least two sets of sample measurements, wherein a respective set of sample measurements of the at least two sets of sample measurements is indicative of one or more signals that are observable by an antenna, wherein a respective set of the at least two sets of sample measurements is measured with a respective antenna of at least two antennas, and wherein the at least two antennas have at least one first distance from one another;
determining time-of-arrival, TOA, difference information indicative of a TOA difference between the at least two sets of sample measurements, wherein at least one TOA difference information is determined based, at least in part, on at least two sets of sample measurements, wherein the determining of the TOA difference information comprises checking whether the TOA difference information reflects the at least one first distance between the at least two antennas.

2. The apparatus according to claim 1, wherein the at least one memory and the computer program code are configured to, with the at least one processor, cause the apparatus further to perform:
obtaining at least capability information of the apparatus, wherein the at least capability information is indicative of at least one of: a number of antennas, the number of antennas comprising the at least two antennas, a respective distance that the respective at least two antennas are spaced from one another, or at least one antenna geometry of the at least two antennas,
wherein the TOA difference information is determined based, at least in part, on the at least capability information.

3. The apparatus according to claim 1, wherein the at least one memory and the computer program code are configured to, with the at least one processor, cause the apparatus further to perform:
refining at least one set of the at least two sets of sample measurements based, at least in part, on the TOA difference information, wherein the at least one set of sample measurements is refined based, at least in part, on the at least one first distance between the at least two antennas.

4. The apparatus according to claim 3, wherein the at least one set of sample measurements of the at least two sets of sample measurements is refined in case the TOA difference information reflects the at least one first distance between the at least two antennas.

5. The apparatus according to claim 1, wherein the at least one memory and the computer program code are configured to, with the at least one processor, cause the apparatus further to perform:
selecting the at least one antenna that gathered the at least one set of sample measurements of the at least two sets of sample measurements representing a shortest TOA measurement as a reference antenna; and
refining the at least one other set of sample measurements of the at least two sets of sample measurements based, at least in part, on the measurements gathered by the selected reference antenna, wherein the at least one other set of sample measurements is refined based, at least in part, on the at least one first distance between the at least two antennas

6. The apparatus according to claim 5, wherein at least one respective antenna of the at least two antennas is selected as the reference antenna in case the TOA difference information does not reflect the at least one first distance between the at least two antennas.

7. The apparatus according to claim 3, wherein the refining of the at least one sample measurement or of the at least one other sample measurement further comprises:
checking the at least two sets of sample measurements based, at least in part, on a Line-of-Sight, LoS, criterion indicative of whether the respective set of sample measurement was gathered as a LoS, or a non-LoS measurement,
wherein the at least one set of sample measurements or the at least one other set of sample measurements is refined in response to the respective set of sample measurements having been gathered as a LoS measurement.

8. The apparatus according to claim 7, wherein the at least one memory and the computer program code are configured to, with the at least one processor, cause the apparatus further to perform
in response to the checking being indicative of a non-LoS measurement:
tagging the respective set of sample measurements as a non-LoS measurement.

9. The apparatus according to claim 3, wherein the at least one memory and the computer program code are configured to, with the at least one processor, cause the apparatus further to perform:
providing the at least two sets of sample measurements.

10. The apparatus according to claim 1, wherein a respective set of sample measurements of the at least two sets of sample measurements is indicative of one or more gathered positioning reference signals received from at least one network node.

11. The apparatus according to claim 1, wherein the apparatus is, or is part of, at least one of, mobile device, an automated guided vehicle—AGV—, or an Internet-of-Things—IoT device—, or the apparatus is, or is part of, at least one of a location management function—LMF—configured to be located at a core network of the mobile communication network, or a location management component—LMC—configured to be located at a radio access network of the mobile communication network.

12. A method, comprising:
gathering at least two sets of sample measurements, wherein a respective set of sample measurement of the at least two sets of sample measurements is indicative of one or more signals that are observable by an antenna, wherein a respective set of the at least two sets of sample measurement is measured with a respective antenna of at least two antennas, and wherein the at least two antennas have at least one first distance from one another;
determining time-of-arrival, TOA, difference information indicative of a TOA difference between the at least two sets of sample measurements, wherein at least one TOA difference information is determined based, at least in part, on at least two sets of sample measurements, wherein the determining of the TOA difference information comprises checking whether the TOA difference information reflects the at least one first distance between the at least two antennas.

13. The method according to claim 12, further comprising:
obtaining at least capability information of the apparatus, wherein the at least capability information is indicative of at least one of: a number of antennas, the number of antennas comprising the at least two antennas, a respective distance that the respective at least two antennas are spaced from one another, or at least one antenna geometry of the at least two antennas,
wherein the TOA difference information is determined based, at least in part, on the at least capability information.

14. The method according to claim 12, further comprising:
refining at least one set of the at least two sets sample measurements based, at least in part, on the TOA difference information, wherein the at least one set of sample measurements is refined based, at least in part, on the at least one first distance between the at least two antennas.

15. The method according to claim 14 further comprising: wherein the at least one set of sample measurements of the at least two sets of sample measurements is refined in case the TOA difference information reflects the at least one first distance between the at least two antennas.

16. The method according to claim 12, further comprising:
selecting the at least one antenna that gathered the at least one set of sample measurements of the at least two sets of sample measurements comprising or representing a shortest TOA measurement as a reference antenna; and
refining the at least one other set of sample measurements of the at least two sets of sample measurements based, at least in part, on the measurements gathered by the selected reference antenna, wherein the at least one other set of sample measurements is refined based, at least in part, on the at least first distance between the at least two antennas.

17. The method according to claim 16, wherein at least one respective antenna of the at least two antennas is selected as the reference antenna in case the TOA difference information does not reflect the at least one first distance between the at least two antennas.

18. The method according to claim 14, wherein the refining of the at least one sample measurement or of the at least one other sample measurement further comprises:
checking the at least two sets of sample measurements based, at least in part, on a Line-of-Sight, LoS, criterion indicative of whether the respective set of sample measurement was gathered as a LoS, or a non-LoS measurement,
wherein the at least one set of sample measurements or the at least one other set of sample measurements is refined in response to the respective set of sample measurements having been gathered as a LoS measurement.

19. The method according to claim 18, further comprising:
in response to the checking being indicative of a non-LoS measurement:
tagging the respective set of sample measurements as a non-LoS measurement.

20. A system, comprising:
at least one of a mobile device, an automated guided vehicle—AGV—, or an Internet-of-Things—IoT—device; and
at least one of Location Management Function—LMF—, or Location Management Component—LMC—;
wherein the at least one of a mobile device, automated guided vehicle, or IoT device or the at least one LMF are configured to be located at a core network of the mobile communication network, or LMC is configured to be located at a radio access network of the mobile communication network and are configured to perform the method according to claim 12.
